(19) United States
(12) Patent Application Publication
(10) Pub. No.: US 2004/0044753 A1
(43) Pub. Date: Mar. 4, 2004

(54) Method and system for dynamic business management of a network

(75) Inventors: Yasufumi Toyoshima, Saratoga, CA (US); Calvin Chen, Cupertino, CA (US)

Correspondence Address: Sheppard Mullin Richter & Hampton LLP, Attention: Mike Encinas, 333 South Hope Street, 48-th Floor, Los Angeles, CA, 90071, US

(73) Assignee: Lucida, Inc.

(21) Appl. No.: 10/087,184

(22) Filed: Feb. 27, 2002

(51) Int. Cl. G06F 15/173

(52) U.S. Cl. 709/223; 709/224

(57) ABSTRACT

A system and method is provided for managing a network using business information based on data from the network elements, where the data includes real time data. One preferred embodiment of the present invention comprises a method for managing a network having a network element. First, a real time variable of the network element is selected for dynamic monitoring in a cell on a spreadsheet. Next, the real time variable is measured. And then the measured real time variable is used, for example, displayed, in the cell. In addition, the measured real time variable can be combined with other business data to form a flexible business analysis application.

### FIELD OF THE INVENTION

The invention relates generally to the field of management of a network, and in particular to the management of a network using business information and more particularly to management of a Virtual Private Network (VPN).

### BACKGROUND OF THE INVENTION

Decades ago, management of networks, specifically computer networks was mostly technically oriented. A Network Operations Center (NOC) was the focus of maintaining and expanding the network. The business people were provided with summarized information based on historical data and in some aspects considered ancillary to managing the network. With the rapid advances in technology and the expansion of the Internet, there has been a great increase in the numbers of network service providers that compete for customers. Thus both customers and service providers are placing greater and greater emphasis on business Management, for example, the cost versus the benefit of a network addition or change. In order to provide a framework on how the business of a network is managed, the telecommunications industry developed the Telecommunications Management Network (TMN) Reference model.

FIG. 1 is a diagram of the TMN model of the prior art. The TMN model typically has five layers, starting with the network element layer 112 and followed by four management layers. Each layer provides a set of capabilities to the upper layers and imposes a set of requirements on the lower layers. The TMN model is shaped like a pyramid because going down the layers increases the amount and technical content of the information, while going up the pyramid concentrates the information into higher levels of abstraction. The bottom layer is the Network Element Layer 112 and includes the actual hardware, e.g., routers, switches, hosts, and servers.

The Element Management layer 114 covers processes that manage the individual network element, e.g., monitoring performance and detecting faults. Typical protocols used in element management layer 114 are the Simple Network Management Protocol (SNMP) or Common Management Information Protocol (CMIP). These protocols allow monitoring and control of an individual network element which has stored on it a Management Information Base (MIB). The majority of “network management” systems commercially available today are actually network element management systems within this layer 116.

The Network Management Layer 116 is concerned with the management of the network as a whole. For example, the creation and supervision of a VPN connection (i.e., a end-to-end path). Hence, for example, alarms detected on individual network elements are not merely displayed against that individual network element, but are also propagated to show what paths and circuits are affected by the fault.

The Service Management Layer 118 maintains the network. As faults arise this layer 118 may direct the Network Management Layer 116 to reroute some paths to minimize the disruption to the network. This layer 118 includes the reporting to the customer of faults, service recovery time, and considering needs for services of different types.

The Business Management Layer 120 is used to monitor and plan the business activities and economy of the entire enterprise, resulting in decisions affecting the lower levels. This layer 120 includes, the process of sales negotiations, including the establishment of Service Level Agreements (SLAs), ordering and billing, trade-offs between investment versus benefits to the network, allocation of resources, and providing service status information to customers.

While business management is now at the top of the pyramid in the TMN model, the business people still get information about the actual hardware that has been abstracted and filtered by lower management layers. Thus there is still the disadvantage that the Business Management Layer 120 is constrained in manipulating the raw data from the Network Element Layer 112. In addition the data the Business Management Layer 120 reviews is still historical. In today's intensely competitive environment, being one step behind is a great disadvantage.

The problems discussed above for a general network, also apply to a Virtual Private Network (VPN). The VPN is an intranet superimposed on the Internet infrastructure. This has cost savings to the business customer by reducing the infrastructure costs normally needed to maintain a dedicated network, and at the same time having the security of an intranet.

FIG. 2 is a network diagram illustrating a VPN of the prior art. A local area network (LAN) 212 is connected to another LAN 216 via the Internet 214. The two LAN's 212 and 216 are two parts of one private network, i.e., intranet. By encapsulating an inner packet from the LAN into an outer packet of the VPN, the inner packet is opaque to the network, e.g., Internet 214 over which the inner packet is routed. This is called “tunneling.” For example, a data packet from LAN 212 reaches a router 220 which has VPN functionality and is encapsulated in an outer packet. The source address of this packet is router 220 and the destination address router 236. The outer packet is sent over the Internet via link 222 to router 224 to link 226 to router 228 to link 230 to router 232 to link 234 to destination router 236. Router 236 then strip off the outer packet for delivery in LAN 216. From the viewpoint of the two LANs 212 and 216 there is a virtual direct path, i.e., tunnel, between routers 220 and 236. From the Internet point of view, if link 226 goes down, the packet can be re-routed via links 240, 244, 248, and 234. Thus the advantage to the customer is a secure network over the Internet and the advantage to the network service provider is flexibility.

VPN protocols can be mapped to the Element Management Layer 114 and the Network Management Layer 116. The SNMP protocol is applicable to the Element Management Layer 114. The IPsec or security protocol is applicable to the Network Management Layer 116. IPsec provides the secure tunnel between, e.g., source router 220 and destination router 236.

Since the TMN model is used for a VPN, there are the same problems as using a typical IP network. The business people still have access problems to the Network Element Layer's data, especially real-time data. Thus there is a need in both general IP networks, as well as, more specifically VPNs, for Business Management Layer to have direct access to the Network Element Layer data in addition to the information from the other layers of the TMN model.

### SUMMARY OF THE INVENTION

The present invention provides a system and method, for managing a network using business information based on data from the network elements, where the data includes real time data. In addition, the real time data can be combined with other business data to form a flexible business analysis application. One preferred embodiment of the present invention comprises a method for managing a network having a network element. First, a real time variable of the network element is selected for dynamic monitoring in a cell on a spreadsheet. Next, the real time variable is measured. And then the measured real time variable is used, for example, displayed, in the cell.

Another embodiment of the present invention comprises a method for displaying real time data from a network element on a display at a client computer, where the client computer is connected to a server via a public communications network, for example the Internet. First, the display shows a spreadsheet having a plurality of cells. A real time variable is assigned to a cell of the plurality of cells, wherein the real time variable is measured from the network element. Then a dynamic update of the real time variable is received via the server from the network element. The dynamic update is displayed in the spreadsheet.

Yet another embodiment of the present invention comprises a server system for managing a network device, wherein the server system is connected to a client computer executing software in an Internet browser. The software is stored in a computer readable medium. The server system comprises: a network interface for receiving from the software a request to monitor a measurable variable of the network element; a data monitor module for periodically monitoring the measurable variable; and a live update module for sending changes to the measurable variable to the software.

An aspect an embodiment of the present invention comprises a memory for storing data for access by an application program being executed on a computer. The memory comprises a data structure stored in the memory, where the data structure comprises a plurality of data objects for use by the application program. The plurality of data objects comprises: an asset data object comprising a physical or logical asset; a profile associated with the asset data object for describing the physical or logical asset; and a value comprising a measured value of the asset data object for dynamically updating the value to the application program.

Another aspect of the present invention comprises a method for dynamically managing a network using business information, where the network includes a network device. First, a real time variable is selected to be dynamically monitored based on a condition in a legal agreement, for example, a Service Level Agreement (SLA). Next, the real time variable is measured using the network element. And then using the measured real time variable, the condition in the legal agreement is checked for compliance.

Yet another aspect of the present invention comprises a method, using a computer display, for a dynamic sales presentation of a network. a sales display is presented, comprising a real time variable of the network, to a customer. During the presentation, the real time variable is updated by measuring a network element of the network and the updated real time variable is displayed to the customer.

These and other embodiments, features, aspects and advantages of the invention will become better understood with regard to the following description, appended claims and accompanying drawings.

### BRIEF DESCRIPTION OF THE DRAWINGS

FIG. 1 is a diagram of a TMN model of the prior art;

FIG. 2 is a network diagram illustrating a VPN of the prior art;

FIG. 3 is a modified TMN model of an embodiment of the present invention;

FIG. 4 is a spreadsheet displayed in a browser window of an embodiment of the present invention;

FIG. 5 is a window including graphical representations of the data in a cell of the spreadsheet of FIG. 4 of another embodiment of the present invention;

FIG. 6 is a flowchart of the set-up process for displaying real time data of an aspect of the present invention;

FIG. 7 is a block diagram of a client-server architecture used in one embodiment of the present invention to provide a Web based network management environment;

FIG. 8 is a data model of the Asset database of one embodiment of the present invention;

FIG. 9 is a flowchart expanding on step 614 of FIG. 6 for the specific case of monitoring a network or device data source of an aspect of the present invention; and

FIG. 10 is a simplified VPN illustrating another aspect of the present invention.

### DETAILED DESCRIPTION OF THE INVENTION

In the following description, numerous specific details are set forth to provide a more thorough description of the specific embodiments of the invention. It is apparent, however, to one skilled in the art, that the invention may be practiced without all the specific details given below. In other instances, well known features have not been described in detail so as not to obscure the invention.

In today's fast paced environment the business layer gets little if any real time information from the network, especially from the network elements which are directly responsible for the customer getting his/her data. The TMN model assumes business people, especially salespersons, are unsophisticated technically and can perform their function by use of analyses of historical data. However, with the explosion of communication technology, business people are much more technically proficient and do not necessarily need all the data filtering of the TMN lower management layers. Such filtering is also disadvantageous since the business people may need to view or combine the raw data in a different way for business analysis. For example, the customer may want to monitor the delay through a particular VPN tunnel to insure that the service provider is keeping below a minimum delay as specified in the SLA. If not here may be certain penalty provisions which may be triggered. Hence the delay is viewed from a business rather than a technical perspective.

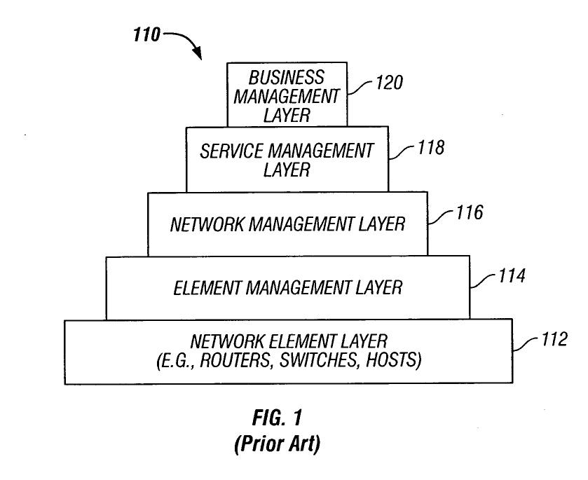

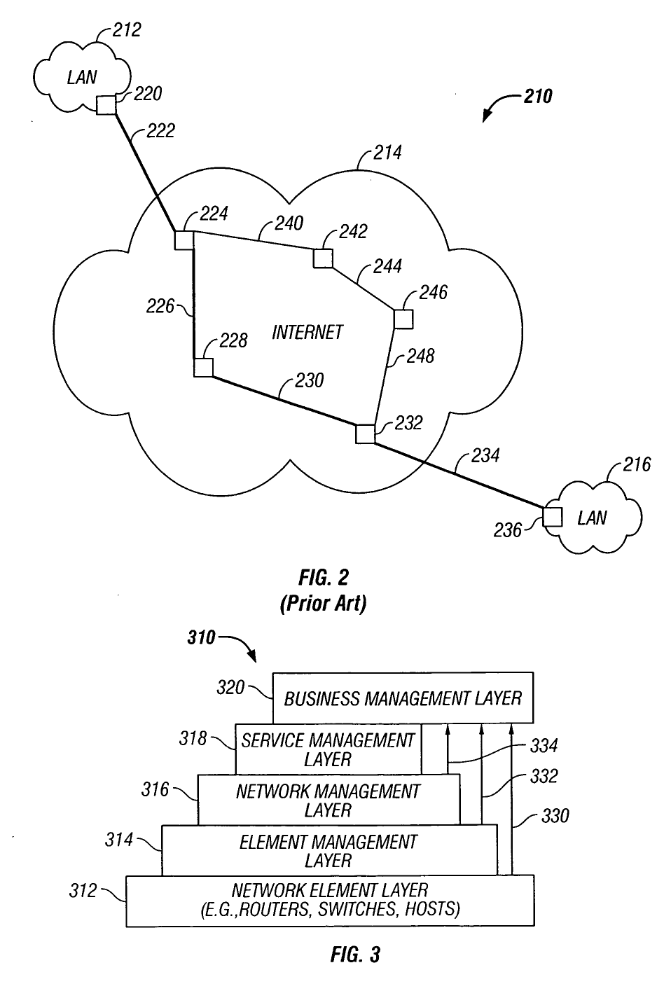

FIG. 3 is a modified TMN model of an embodiment of the present invention. The modified model has the same first four layers as FIG. 1. the Network Element Layer 312, the Element Management Layer 314, the Network Management Layer 316, and Service Management Layer 318. The Business Management Layer 320 in FIG. 3 has been expanded to include real time data from the Network Element Layer 312 (direct connection 330), the Element Management Layer 314 (direct connection 332), and the Network Management Layer 316 (direct connection 334). In one embodiment of the present invention a network element, e.g., router, switch, hub, gateway, host, server, or PC, has stored on it a MIB. A server requests real time information, e.g., CPU usage, from the MIB using the SNMP protocol. The real time information is then displayed in a form that a business user can easily understand, such as a spreadsheet, e.g., Microsoft® Excel of Microsoft Corporation. The spreadsheet includes a plurality of cells, where each cell may include text, a number, a formula, etc.

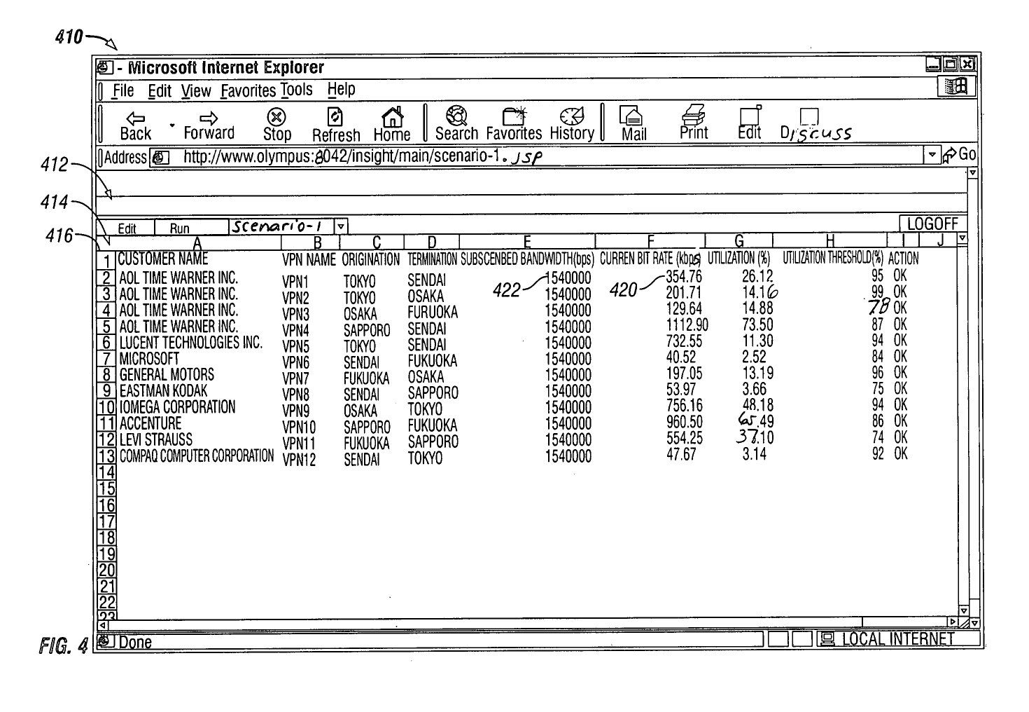

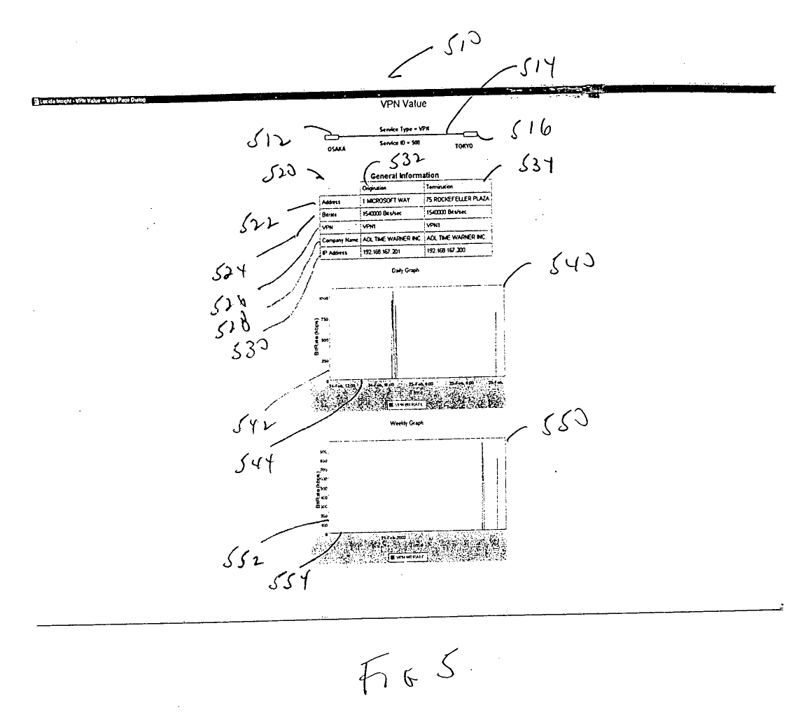

FIG. 4 is a spreadsheet 412 displayed in a browser window 410 of an embodiment of the present invention. The spreadsheet 412 has a plurality of columns 414, e.g., “A,” “B,” “C,” “D,” “F,” “G,” and “H,” and a plurality of rows 416, e.g., 1 to 13. The cells for the columns A to F of row 1, have the text labels: “Customer Name,” “VPN Name,” “Origination,” “Termination,” “Subscribed Bandwidth (bps),” “Current Bit Rate (Kbps),” respectively. Row 2 columns A to F show an example of a customer: “AOL TIME WARNER INC.,” a VPN tunnel: VPN1, the origination or source of the VPN tunnel: “TOKYO,” the termination or destination of the VPN1: “SENDAI,” the subscribed bandwidth: “1540000,” and the current (real time) bit rate 420: “354.76 Kbps.” Although not shown, the current bit rate 420 is being updated periodically and shows a real time value of the bit rate of VPN1.

Users of the spreadsheet of FIG. 4 can either use separately or in combination the static data they entered and/or the real time data sources they define to form cells on the spreadsheet. From these data cells, they can do further analysis by using those cells as a base to define formulas and calculations in new cells. An embodiment of the present invention provides a list of real time measured and historical variables, which the user can combine in customized formulas. These formulas are stored on the user's machine or on a secure place on the server to be accessible by the user alone. Thus an aspect of this invention is to provide a list of commonly used measured and historical variables to all users with each user developing their own business analysis formulas. In addition customized measured values can be developed for each user.

A business action can be defined in a cell to send out notification to the user or other designated person, via, e.g., email or telephone call. The business action is triggered, when a user set condition is met. For example, when the current bit rate 420 is within a set amount of the subscribed bandwidth 422, an email is sent to the customer indicating that they might want to purchase more bandwidth from the service provider.

FIG. 5 is a window including graphical representations of the data in a cell of the spreadsheet of FIG. 4 of another embodiment of the present invention. The window of FIG. 5 is displayed when, for example, the current bit rate cell 420 is selected in FIG. 4. A graph showing the VPN link 514 between Osaka 512 and Tokyo 516 is shown at the top of the window. The link in one embodiment changes color depending upon its status. For example, when the current bit rate 420 goes above (or in other examples, goes below) a certain threshold the link turns yellow, otherwise it is green. A table 520 shows information associated with the link's origination or source 532 and termination or destination 534, such as, address 522, subscribed bit rate 524, VPN name 526, company name 528, and IP address 530. There are two graphs 540 and 550 showing the VPN bit rate (y-axes 542 and 552 in Kbps) for a daily (hourly x-axis 544) and a weekly (daily x-axis 554) period, respectively, for link 514. In addition, a monthly (weekly x-axis) period, and/or a yearly (monthly x-axis) period(s) can also be shown.

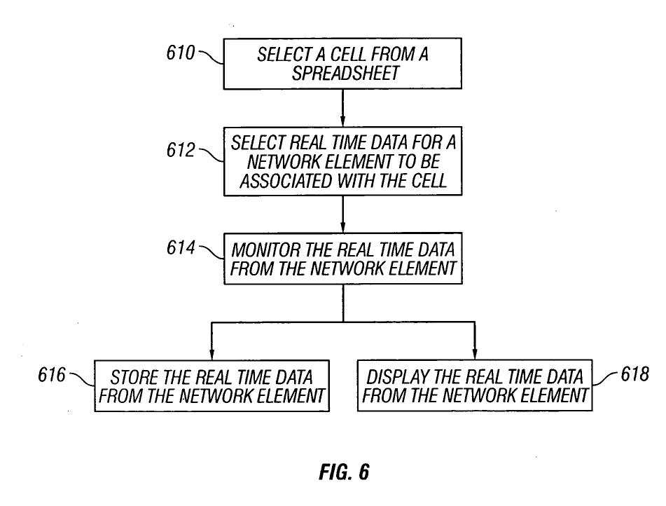

FIG. 6 is a flowchart of the set-up process for displaying real time data of an embodiment of the present invention. At step 610 a cell is selected from the spreadsheet which is to be associated with a real time variable. Next a real time variable from a list of real time variables for a network element is selected (step 612). At step 614 the real time data is monitored from the network element and the updates posted to the variable. The real time variable is stored in memory for historical use, e.g., averaging, (step 616) and displayed in the spreadsheet cell and/or on a graphical representation (step 618).

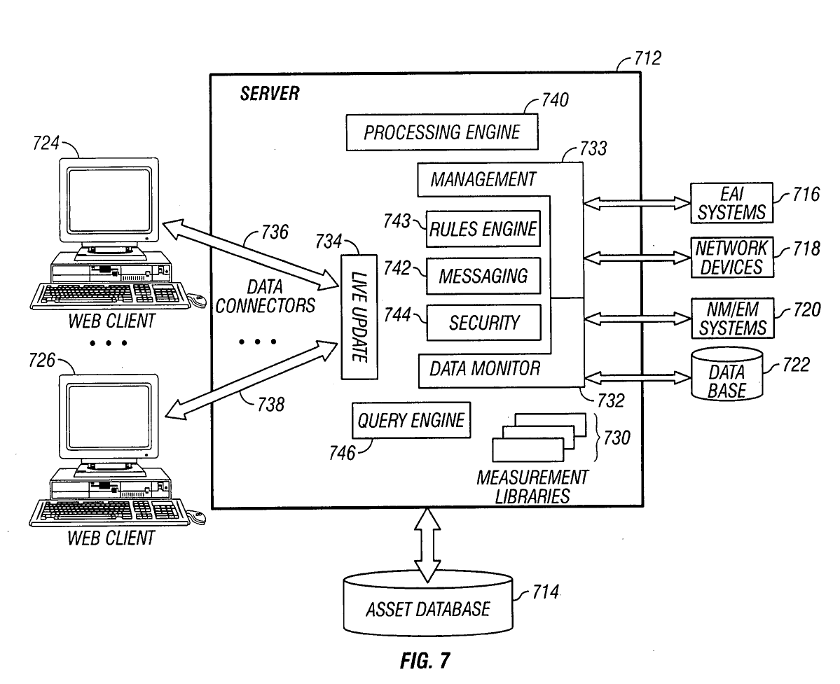

FIG. 7 is a block diagram of a client-server architecture used in one embodiment of the present invention to provide a Web based network management environment. From anywhere on the Internet, a user defines his/her own business analysis application on a spreadsheet at the client computer. The user can simply type in what they want to see on the spreadsheet and define formulas or calculations between cells. The spreadsheet is embedded in a web page to allow a user to define data, behavior, format, and source of the real time data in one or more cells in the spreadsheet. A spreadsheet defined by user can be saved to a server, which allows the user to retrieve the spreadsheet from anywhere the client can be executed. Different users only see their own created sheets. In another embodiment different users can view each others' sheets.

In designing the spreadsheet, the user can define a data source in their spreadsheet in the browser. In executing the spreadsheet, through the definition, the server binds the cell to a data connector. Upon any subscribed data change, a live update will be sent to client from the server through a secure connection. The real-time feed may come from a variety of data sources. This includes network elements/devices 718 (e.g., routers), Network Management and Element Management systems (NM/EM Systems 720), database systems 722 and Enterprise Information Systems (EAI Systems 716). Users can pull or push data from/to all these sources and customize their spreadsheet, providing various views of the same data. For example, the Sales Department may create their own spreadsheet to monitor new business opportunities to maximize the revenue, a Network Operations Center may be interested in Packet Drops etc. and the end customer may be interested in the impact on their SLA or Utilization.

FIG. 7 comprises: a client running on a user's computer with Web access, e.g., Web client computers 724 and 726; a server computer 712; a plurality of data sources, e.g., EAI Systems 716, Network Devices 718, NM/EM Systems 720, and Databases 722; and an Asset database 714. The Web client computers are connected to the server 712 which is in turn connected to the data sources and the Asset Database 714. The server 712 comprises: a Processing Engine 740, Data Connectors, e.g., 736 and 738, Network Measurement Libraries 730, a Management module 733, a Live Update module 734, a Security Module 744 a Rules Engine 743, a Messaging module 742, a Data Monitor module 732, and a Query Engine 746. The security module 744 provides user authentication, role based authorization and digital encryption of any data transfer. The security module 744 defines the user profile and permissions. The Rules Engine 743 maintains the business rules that are triggered when the data, real time and/or static, meet a user defined condition, e.g., exceed a threshold or cause an event to occur.

The client is software using the most popular desktop application, the Microsoft® Excel Spread Sheet component, and runs on a Web client computer, e.g., 724 and 726. The spreadsheet runs within a web browser and can pull data from the various data sources in real-time. Users can use standard Excel formulas to manipulate this real-time data and save their individual applications on the server 712. Clients can also specify actions to be taken when a particular data change or event occurs. These actions can vary from sending e-mail to starting complex workflow processes.

The server 712 is a high performance, distributed, multi-threaded computer, which can pull data from various data sources varying from real-time network to Enterprise Information Systems, and the server can directly update interested clients. A user selects from a list of real time variables for a data source, e.g., a source edge router from the Measurement Libraries 730. The Data Monitor module 732 then monitors the router and then sends via the Live Update module 734 an update to the user when the data changes. The server 712 maintains a secure connection between the client and the server, and whenever the data change occurs, the server will send the update using this channel. The Data Monitor module 732 also monitors the data source even when the user is not currently logged into the system and may process those data changes for various actions. For example, the Data Monitor module 732 may automatically trigger the messaging module 742, when a threshold is exceeded. Also, the server 712 can update the data source, if it is allowed to be updated.

The Management Module 733 includes the control of various assets. For example: user management including adding, modifying, and deleting users and their profiles; server management, including startup, shutdown, back-up, etc.; network management, including, controlling the network elements and EAI systems; and database management of the Asset Database 714. The Network Devices 718 can be controlled through use of SNMP.

A set of measurement libraries 730 provide the various characteristics to be measured on the network. This comprises, utilization, packet drop, jitter, delay, bit rate, etc. on IP and VPN networks. These measurements are done at real-time and clients may correlate these measurements to data from other data sources like customer information from an EIS system.

The Query Engine 746 provides a sophisticated query generation tool. This query generation works with the subscription mechanism to identify the database related data sources the user is interested in. The user provides only a high-level, logical information in their own particular terminology (e.g. The sales person may use their terms to refer to the same data source). The Query Engine 746 then maps this subscription information onto physical tables, views and columns and generates dynamic queries.

The Asset Database 714 is indexed by asset. An “asset” includes a physical asset, e.g., router, cable, computer, and a logical asset, e.g., VPN service, IP address, performance of a network link. Each asset has associated with it a profile and values, including measured values. An example is give in Table 1 below:

TABLE 1

| Asset | Profile | Value |
|---|---|---|
| Service | User Name | Revenue |
| | Service Type | Profit |
| | Location | SLA Status |
| | Subscribed SLA | Security Status |
| | Subscribed Bandwidth | |
| | Service In/Out | |
| Router | Equipment Type | Bit Rate |
| | Location | Bandwidth Utilization |
| | IP Address | Router Load (CPU.Memory. |
| | Port Number | MTTR/MTBF |
| | Bandwidth | |
| IP Address | Total Address Pool | Used/Not-used |
| | Blocked Address | Block Availability |
| | Location | Duration of Use |

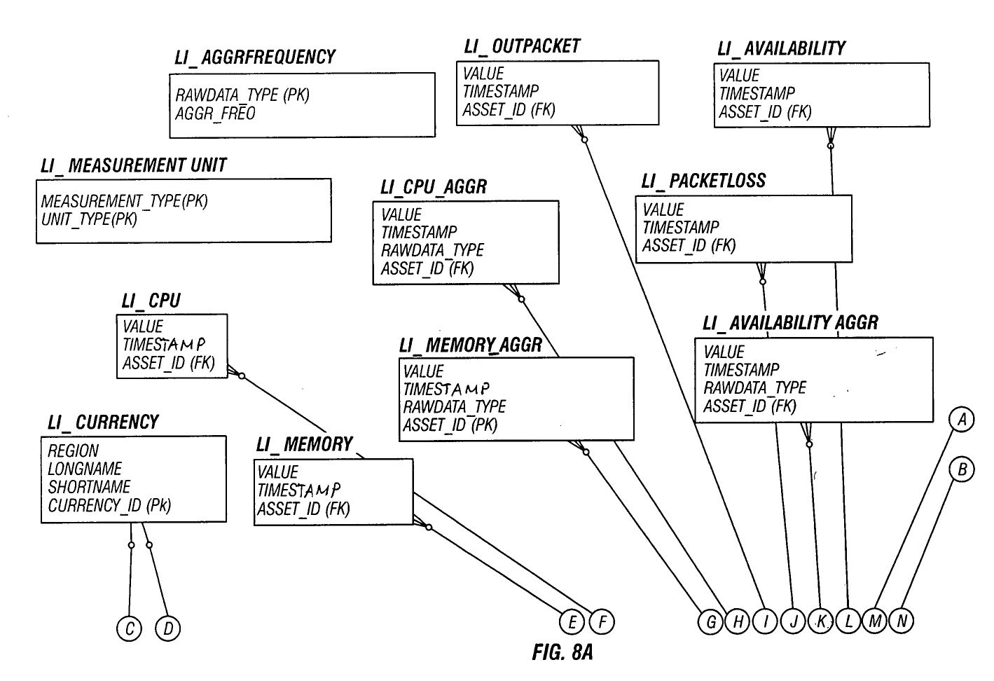

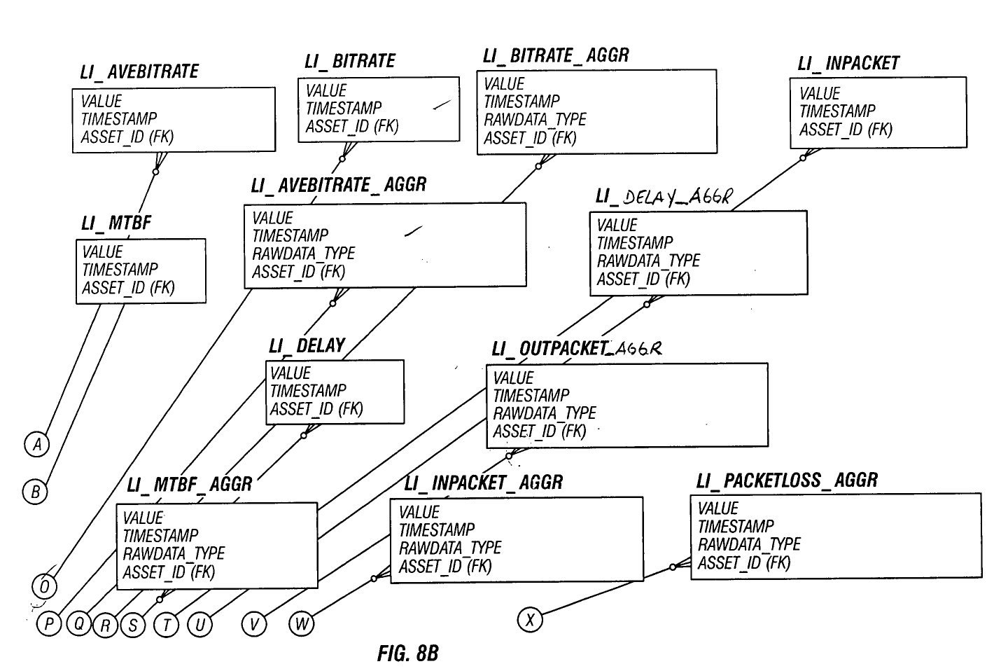

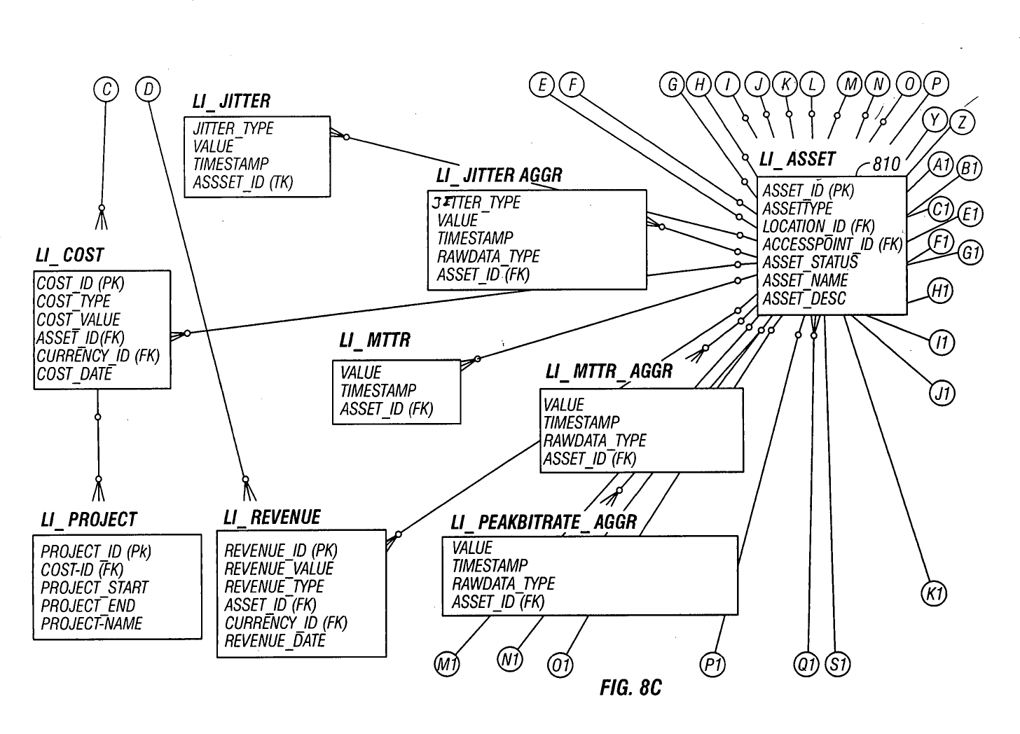

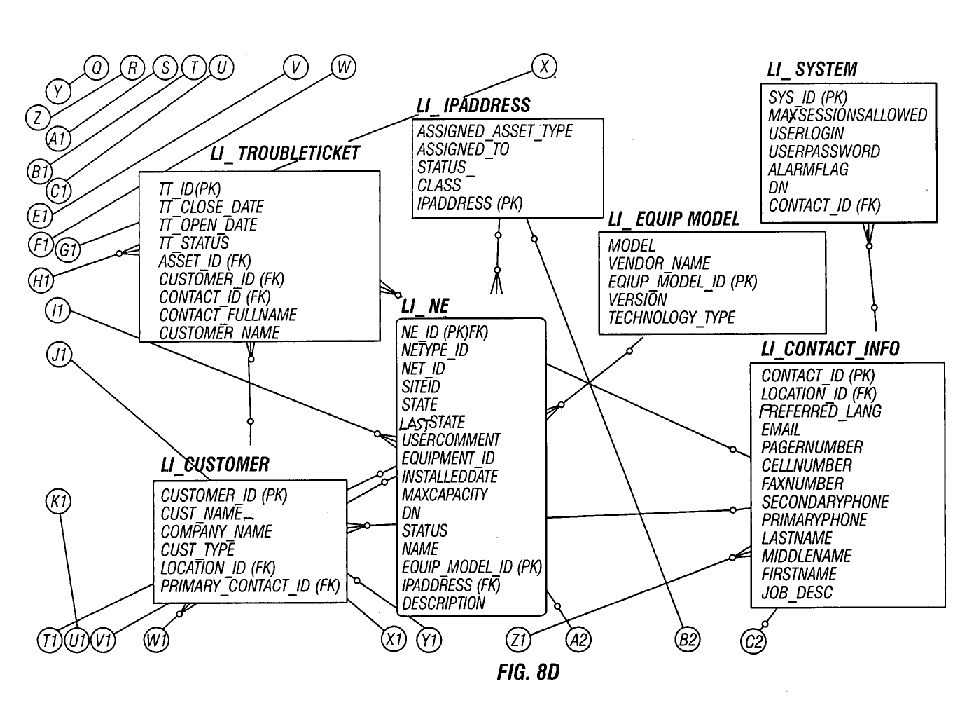

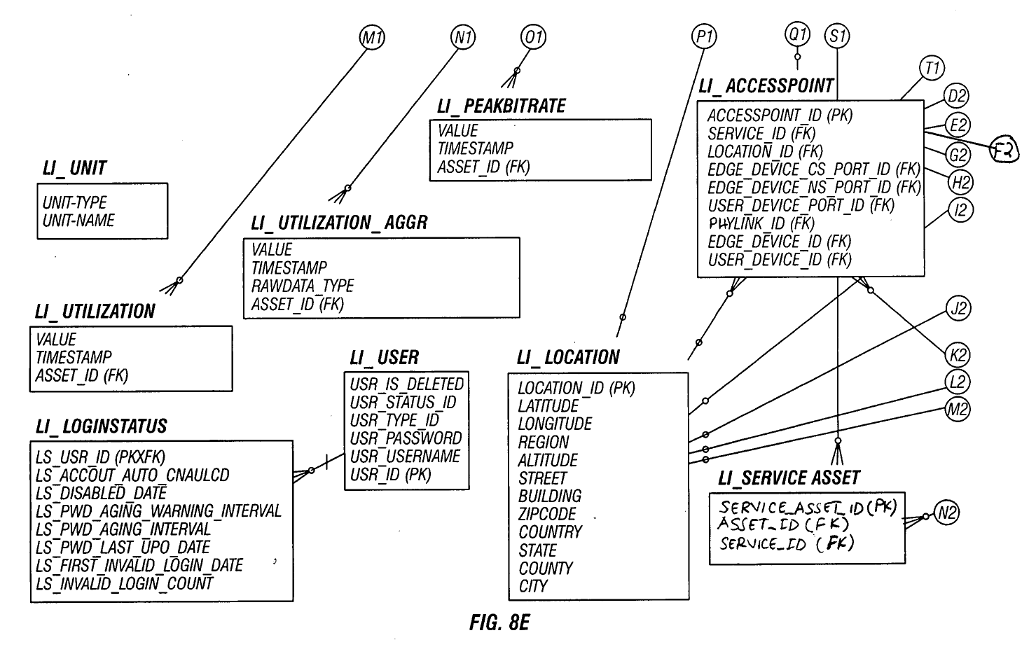

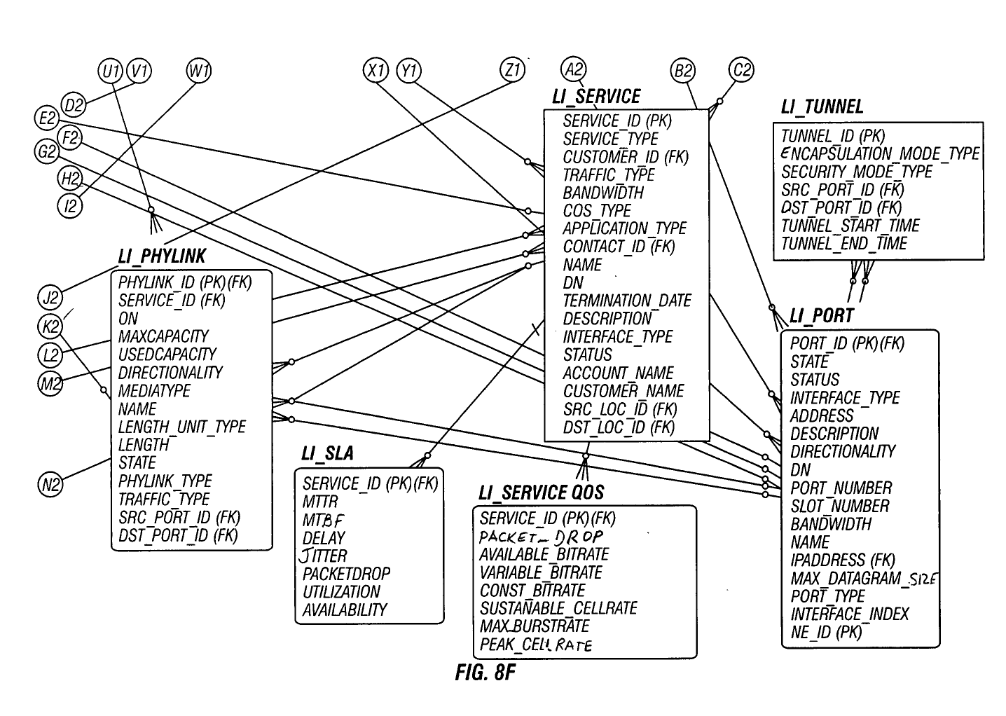

FIG. 8 is a data model of the Asset database of one embodiment of the present invention. The Asset Database 714 can be implement as a relational or objected oriented database or a combination thereof. The main focal point of the database is the asset object LI_ASSET 810. Associated with the asset object are a plurality of characteristics, including, measured values such as bit rate (LI_BITRATE), delay (LI_DELAY), packet loss (LI_PACKETLOSS), jitter (LI_JITTER) and so on.

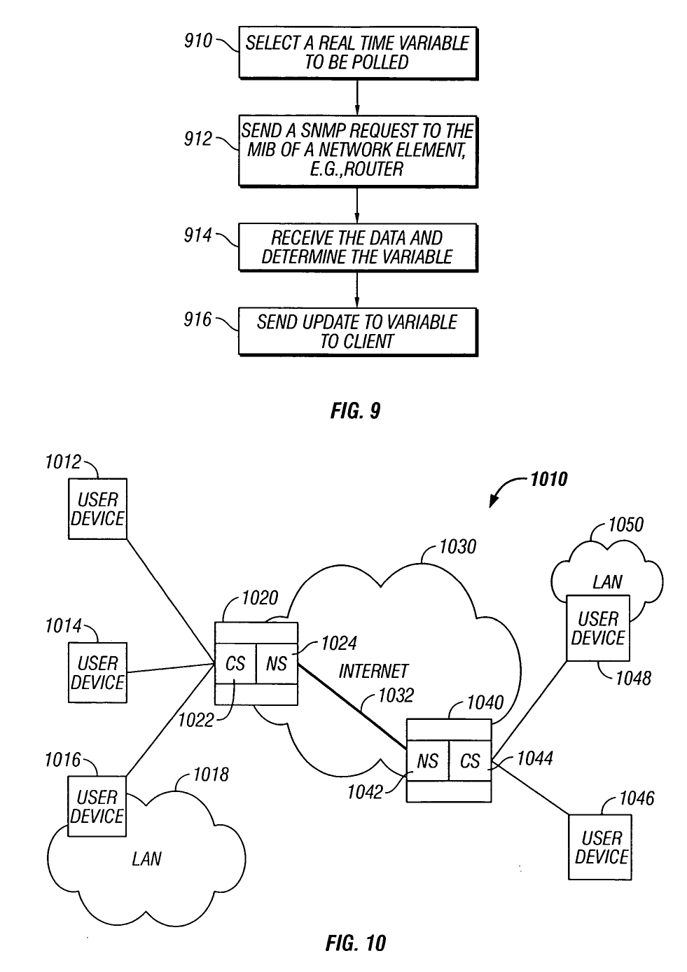

FIG. 9 is a flowchart expanding on step 614 of FIG. 6 for the specific case of monitoring a network or device data source of an embodiment of the present invention. At step 910 a real time variable from the Measurement Libraries 730 is selected to have its associated network element, i.e. asset, polled by the server 712. An SNMP request is sent by the server 712 to the MIB stored on the network element (step 912). The network device responds by sending the requested data back to the server 712. The Processing Engine 740 then may use a formula to calculate the variable from the data or use the data directly to determine the real time variable (step 914). At step 916 an update is sent to the client via the live update module 734, if the variable has changed. The variable may also be stored in the Asset Database 714 in a data structure associated with the network element. The Rule Engine 734 is also checked to determine if a business rule has been triggered.

FIG. 10 is a simplified VPN illustrating an embodiment of the present invention. A user device 1012 is connected to a router 1020. The user devices 1012 and 1014 may be user computers or hosts. The user device 1016 may be a router, having a VPN service, that connects to a LAN 1018. The router 1020 is called an edge device and is connected via a VPN tunnel 1032 over the Internet 1030 to another edge device 1040. The edge device 1040 is then connected to user device 1046, e.g., a user computer, and user device 1048, e.g., a router for LAN 1050. Each edge device has a Network Side (NS) connecting the edge device to the Internet 1030 and a Customer Side (CS) connecting the edge device to a customer or user device. Edge device 1020 has CS 1022 and NS 1024. Edge device 1040 has CS 1044 and NS 1042.

For illustration purposes, user device 1012 sends data to user device 1046. User devices 1012 and 1046 are also called Customer Premises Equipment (CPE). User device 1012 is called the source user device. User device 1046 is called the destination user device. Edge device 1020 is the source edge device and is the start of the VPN tunnel 1032. Edge device 1040 is the destination edge device and is the end of the VPN tunnel 1032.

Table 2 shows examples of real time variables in the MIBs of source and destination user devices, i.e., customer premise IP assets, that are monitored by the server 712. The port interface type, e.g., DCE or RS-232, information is required, when the user device is a Customer Premises Equipment (CPE) router, and when a carrier class managed VPN service is provided to the CPE router by a service provider. There are various business uses of this type information. Marketing of a service provider uses the information for forecasting to equipment vendors and pricing. Sales of a service provider uses the information to determine ease of service or bandwidth upgrade. And the customer uses this information internally for determining cost of any upgrades.

TABLE 2
Customer Premise IP Asset Performance

| | Information | Method of | |
|---|---|---|---|
| Variable | Source | Retrieval | Calculation Method |
| Source User | Poll Source | RFC 1213 MIB | Query Database, after auto- |
| Device Port | User Device | | discovery gets this data |
| CS Interface | | | from ifType in RFC MIB |
| Type | | | and stores into Asset |
| | | | Database |
| Destination | Poll | RFC 1213 MIB | Query Database, after auto- |
| User Device | Destination | | discovery gets this data |
| Port CS | User Device | | from ifType in RFC MIB |
| Interface | | | and stores into Asset |
| Type | | | Database |

Table 3 shows examples of real time variables used at the source edge device 1020 on both the CS 1022 and NS 1024 sides. These relate to the Source Edge IP Asset, i.e., router 1020, performance. There is also a similar table for the Destination Edge IP Asset, i.e., router 1040, performance, which is not shown in order not to obscure the invention. Business uses of this information include: for available port numbers, the service provider tracks and forecasts network asset usage by location and performs equipment forecasting and ordering; for bit rates, planning & marketing of the service provider identifies network asset utilization, used in dimensioning networks, and the customer can view real time VPN CoS throughput information; and for CPU and memory utilization, marketing of the service provider can determine asset utilization.

TABLE 3
Source Edge IP Asset Performance

| | Information | Method of | |
|---|---|---|---|
| Variable | Source | Retrieval | Calculation Method |
| Source Edge | Source Edge | RFC 1213 MIB | Query Database, after auto-discovery gets |
| Device CS | Device | | this data from ifTable in RFC MIB and |
| Available | | | stores into Asset Database |
| Port #'s | | | |
| Source Edge | Source Edge | RFC 1213 MIB | Query Database, after auto-discovery gets |
| Device NS | Device | | this data from ifTable in RFC MIB and |
| Available | | | stores into Asset Database |
| Port #'s | | | |
| Source Edge | Source Edge | RFC 1213 MIB | BitRateIn = (Delta ifInOctets × 8)/ |
| Device CS | Device | | (Delta # of seconds × 1000) |
| Port Bit Rate | | | |
| IN | | | |
| Source Edge | Source Edge | RFC 1213 MIB | BitRateOut = (Delta ifOutOctets × 8)/ |
| Device CS | Device | | (Delta # of seconds × 1000) |
| Port Bit Rate | | | |
| OUT | | | |
| Source Edge | Source Edge | RFC 1213 MIB | AverageBit Rate = ((Delta ifInOctets + |
| Device CS | Device | | Delta ifOutOctets )*8)/(Delta # of |
| Port Average | | | seconds × 1000) |
| Bit Rate | | | |
| Source Edge | Source Edge | Process MIB | When the Cisco IOS software version is |
| Device CPU | Device | | below 12.0(3)T: busyPer is from the |
| Utilization | | | OLD-CISCO-SYS MIB; or |
| | | | when the Cisco IOS software version is |
| | | | 12.0(3)T or above: cpmCPUTotal5sec is |
| | | | from the CISCO-PROCESS MIB |
| Source Edge | Source Edge | Chassis MIB | When the Cisco IOS software version is |
| Device | Device | | 11.1 or below: Utilization = |
| Memory | | | (processorRam − freeMem/ |
| Utilization | | | processorRam) × 100 freemMem is from |
| | | | the OLD-CISCO-SYS MIB. |
| | | | processorRam is from the OLD-CISCO- |
| | | | CHASIS MIB; or |
| | | | when the Cisco IOS software version is |
| | | | greater than 11.1: Utilization = |
| | | | (ciscoMemoryPoolUsed/ |
| | | | (ciscoMemoryPoolUsed+ciscoMemory |
| | | | PoolFree)) × 100 ciscoMemoryPoolUsed |
| | | | is from the CISCO-MEMORY-POOL |
| | | | MIB. ciscoMemoryPoolFree is from the |
| | | | CISCO-MEMORY-POOL MIB. |

Table 4 shows examples of real time IP & VPN performance variables used for the tunnel 1032 between the source edge device 1020 and the destination edge device 1040. Some of the real time variables in Table 4 such as “One Way Delay,” and “One Way Jitter,” can be accumulated to form averages which can be either an average over a fixed time interval, e.g., hourly, daily, weekly, or/and monthly or an average using a moving window, e.g., that adds the new measurement to a weighted value of the past measurements. Business uses of this information include: sales of the service provider uses the information for negotiating SLA with customers (End Customers, Peer ISP's, Peer Backbone Providers, Wireless Service Providers, ASP's); marketing people of the service provider can perform pricing and product management (Class of Service, i.e., CoS classification), and cost and revenue implications on business; sales people of the service provider can provide a normalized comparative graphical view to the customer of the competitors' pricing (CoS tier pricing is also mapped on the same graph), and they can show the need for a CoS upgrade. The customer can view real time VPN performance, SLA compliance, and service differentiation by different service providers.

TABLE 4
IP & VPN Network Performance

| | Information | Method of | |
|---|---|---|---|
| Variable | Source | Retrieval | Calculation Method |
| One Way | Source & | RTTMON MIB | “From CISCO-RTTMON MIB: |
| Packet Loss | Destination | | ForwardPacket Loss = |
| | Edge Device | | (rttMonJitterStatsPacketLossSD/ |
| | | | (rttMonJitterStatsPacketLossSD + |
| | | | rttMonJitterStatsNumOfRTT)) |
| | | | BackwardPacket Loss = |
| | | | (rttMonJitterStatsPacketLossDS/ |
| | | | (rttMonJitterStatsPacketLossDS + |
| | | | rttMonJitterStatsNumOfRTT))” |
| Delay | Source & | RTTMON MIB | From CISCO-RTTMON-MIB: |
| | Destination | (or alternatively | Delay = |
| | Edge Device | ICMP Probe | rttMonLatestRttOperCompletionTime; |
| | | method) | (or alternatively send an ICMP probe |
| | | | request packet from Originating to |
| | | | Termination router at time T1 and record |
| | | | the destination time T2. Then T1-T2) |
| | | | will be the total One Way delay adjusted |
| | | | with the time difference between the |
| | | | Originating and Destination Clocks.— |
| | | | Information is contained in the RTT |
| | | | MIB in Edge Router) |
| One Way | Source & | RTTMON-MIB | Real Time Variance of Delay from |
| Jitter | Destination | | Mean Delay. |
| | Edge Device | | “From CISCO-RTTMON-MIB: |
| | | | ForwardJitter = |
| | | | (rttMonJitterStatsSumOfPositiveSD + |
| | | | rttMonJitterStatsSumOfNegativeSD)/ |
| | | | (rttMonJitterStatsNumOfPositiveSD + |
| | | | rttMonJitterStatsNumOfNegativesSD) |
| | | | BackwardJitter = |
| | | | (rttMonJitterStatsSumOfPositiveDS + |
| | | | ttMonJitterStatsSumOfNegativeDS)/ |
| | | | (rttMonJitterStatsNumOfPositiveDS + |
| | | | rttMonJitterStatsNumOfNegativesDS)” |
| Average | History | RFC1213 MIB | At END1 = (max(Delta ifInOctets, Delta |
| Bandwidth | | | ifOutOctets) × 8 × 100)/((Delta # of |
| Utilization | | | seconds) × ifSpeed) |
| | | | At END2 = (max(Delta ifInOctets, Delta |
| | | | ifOutOctets) × 8 × 100)/((Delta # of |
| | | | seconds) × ifSpeed) |
| | | | AverageBandwidthUtilization = |
| | | | (END1 + END2)/2 |
| Availability | Source & | ICMP Method— | ((Total # of Pings received)/(Total |
| | Destination | Pinging from | #Pings Sent)) * 100 (destination edge |
| | Edge Device | Originating | device IP address required) |
| | | Router to | |
| | | Terminating | |
| | | Router—Interface | |
| | | Group MIB, and | |
| | | others | |

Table 5 shows examples of some the IPSec VPN real time performance variables used for the tunnel 1032 between the source edge device 1020 and the destination edge device 1040. IPSec provides a set of security services, e.g., authentication, data confidentiality, used in the IP transport or IP tunnel modes, e.g., VPN tunnel 1032. As many variables in Table 5 are similar to the variables in Table 4, they are not repeated in order not to obscure the invention. Business uses of this information are similar to those listed for Table 4 above, but with a focus on the security aspects of the tunnel 1032.

TABLE 5
IPSec VPN Network Performance

| | Information | Method of | |
|---|---|---|---|
| Variable | Source | Retrieval | Calculation Method |
| IPSec Tunnel | Source & | IPSEC-FLOW- | From CISCO-IPSEC-FLOW- |
| Total Packet | Destination | MONITOR | MONITOR-MIB: |
| Drop | Edge Device | MIB | IPSecTunnelPacketDrop = |
| | | (or alternatively | cipSecTunInDropPkts + |
| | | IPSec Flow | cipSecTunOutDropPkts + |
| | | Monitor MIB, | cipSecTunInReplayDropPkts + |
| | | Interface Group | cipSecTunOutReplayDropPkts |
| | | MIB) | (or alternatively |
| | | | ((CipSecTunInDropPkts) − |
| | | | (CipSecTunOutDropPkts)) + |
| | | | ((CipsecTunInReplayDropPkts) − |
| | | | (CipsecTunOutReplayDropPkts)) |
| | | | where CipSecTunInDropPkts and |
| | | | CipSecTunInReplayDropPkts are |
| | | | at the Originating Router and the |
| | | | complements to these Mibs are |
| | | | from the Terminating Router.) |
| IPSeC | Source & | IPSec Flow | From CISCO-IPSEC-FLOW |
| Tunnel | Destination | Monitor MIB, | MONITOR-MIB: |
| bandwidth | Edge Device | | Utilization at END1 = (max(Delta |
| Utilization | | | cipSecTunInOctets, Delta |
| | | | cipSecTunOutOctets) × 8 × 100)/ |
| | | | ((Delta # of seconds) × ifSpeed) |
| | | | Utilization at END2 (max(Delta |
| | | | cipSecTunInOctets, Delta |
| | | | cipSecTunOutOctets) × 8 × 100)/ |
| | | | ((Delta # of seconds) × ifSpeed) |
| | | | BandwidthUtilization = (END1 + |
| | | | END2)/2 |

While the embodiments described above are for IP and VPN networks, the scope of the present invention is much broader. For example, the same concepts can be applied to IPX, Synchronous Optical Network (SONET), Synchronous Digital Hierarchy (SDH), Wavelength Division Multiplexing (WDM), Wireless network, Fiber Distributed Data Interface (FDDI), TL1 (Transaction Language One (TL1), and other network/communication protocols.

Although specific embodiments of the invention have been described, various modifications, alterations, alternative constructions, and equivalents are also encompassed within the scope of the invention. The described invention is not restricted to operation within certain specific data processing environments, but is free to operate within a plurality of data processing environments. Additionally, although the invention has been described using a particular series of transactions and steps, it should be apparent to those skilled in the art that the scope of the invention is not limited to the described series of transactions and steps.

Further, while the invention has been described using a particular combination of hardware and software, it should be recognized that other combinations of hardware and software are also within the scope of the invention. The invention may be implemented only in hardware or only in software or using combinations thereof.

The specification and drawings are, accordingly, to be regarded in an illustrative rather than a restrictive sense. It will, however, be evident that additions, subtractions, deletions, and other modifications and changes may be made thereunto without departing from the broader spirit and scope of the invention as set forth in the claims.

What is claimed is:

1. A method for managing a network comprising a network element, said method comprising:
selecting a real time variable of said network element for dynamic monitoring in a cell on a spreadsheet;
measuring said real time variable of said network element; and
using said measured real time variable in said cell.

2. The method of claim 1 wherein said real time variable is measured by polling said network element.

3. The method of claim 1 wherein said using said measured real time variable includes displaying said measured real time variable in said cell.

4. The method of claim 1 wherein said measured real time variable is displayed as part of a graph.

5. The method of claim 1 wherein said measured real time variable is stored in a memory.

6. The method of claim 1 wherein said measured real time variable is sent to said cell only if said measured real time variable changes.

7. The method of claim 1 wherein said using said measured real time variable includes triggering a business action, when said measured real time variable satisfies a predetermined condition.

8. The method of claim 7 wherein said business action includes a selection from a group consisting of sending an email, sending a phone message, triggering an event in a workflow process, and any combination thereof.

9. The method of claim 7 wherein said predetermined condition is exceeding a predetermined threshold.

10. A method for displaying real time data from a network element on a display at a client computer, said client computer connected to a server via a public communications network, said method comprising:
displaying on said display a spreadsheet comprising a plurality of cells;
assigning a real time variable to a cell of said plurality of cells, wherein said real time variable is measured from said network element;
receiving a dynamic update of said real time variable via said server; and
displaying said dynamic update in said spreadsheet.

11. The method of claim 10 wherein network element is part of a Virtual Private Network (VPN) connection.

12. The method of claim 10 further comprising displaying a graph of historical values of said real time variable.

13. The method of claim 10 further comprising displaying a status of a network link associated with said network element.

14. The method of claim 13 wherein said network link is a VPN link.

15. The method of claim 10 wherein said dynamic update is displayed in said cell on said spreadsheet.

16. The method of claim 10 wherein said dynamic update is combined with static data before being displayed on said spreadsheet.

17. The method of claim 10 wherein said dynamic update triggers a business action when a predetermined condition is satisfied.

18. The method of claim 17 wherein said wherein said business action includes a selection from a group consisting of sending an email, sending a phone message, triggering an event in a workflow process, and any combination thereof.

19. A server system for managing a network device, wherein said server system is connected to a client computer executing software in an Internet browser, said software stored in a computer readable medium, said server system comprising:
a network interface for receiving from said software a request to monitor a measurable variable of said network element;
a data monitor module for periodically monitoring said measurable variable; and
a live update module for sending changes to said measurable variable to said software.

20. The server system of claim 19 wherein said periodically monitoring said measurable variable comprises polling a MIB of said network element using SNMP.

21. The server system of claim 19 wherein said software comprises a spreadsheet program.

22. The server system of claim 19 wherein said network element is part of a VPN.

23. The server system of claim 19 further comprising an asset database.

24. The server system of claim 23 wherein said network element is associated with an asset object of said asset database.

25. The server system of claim 23 wherein said asset database is an objected oriented database, relational database, or a combination thereof.

26. A memory for storing data for access by an application program being executed on a computer, comprising:
a data structure stored in said memory, said data structure comprising a plurality of data objects for use by said application program, said plurality of data objects comprising:
an asset data object comprising a physical or logical asset;
a profile associated with said asset data object for describing said physical or logical asset; and
a value comprising a measured value of said asset data object for dynamically updating said value to said application program.

27. The memory of claim 26 wherein said logical asset is a device selected from a group consisting of a router, switch, hub, host, server, personal computer, and gateway.

28. The memory of claim 26 wherein said application program is a spreadsheet program.

29. A method for dynamically managing a network using business information, said network comprising a network device, comprising:
selecting a real time variable to be dynamically monitored based on a legal agreement;
measuring said real time variable using said network element; and
using said measured real time variable, determining if a condition in said legal agreement is met.

30. The method of claim 29 wherein said legal agreement is a Service Level Agreement (SLA).

31. The method of claim 29 wherein said network is a VPN.

32. A method, using a computer display, for a dynamic sales presentation of a network, comprising:
presenting said dynamic sales presentation on said computer display to a customer, said dynamic sales presentation, comprising a real time variable of said network;
during said presenting, updating said real time variable by measuring a network element of said network; and
displaying said updated real time variable to said customer.

33. The method of claim 32 wherein said network is a VPN.

34. The method of claim 32 further comprising relating said updated real time variable to cost information.

35. A system for managing a network comprising a network element, comprising:
means for selecting a real time variable of said network element, wherein said real time variable is dynamically monitored in a cell on a spreadsheet;
means for measuring said real time variable of said network element; and
means for using said measured real time variable in said cell.
